(19) United States
(12) Patent Application Publication
(10) Pub. No.: US 2018/0077407 A1
(43) Pub. Date: Mar. 15, 2018

(54) SPORTS VIRTUAL REALITY SYSTEM

(71) Applicant: Catapult Group International Ltd, Docklands, Victoria (AU)

(72) Inventor: Michael Young, Glen Iris, Victoria (AU)

(21) Appl. No.: 15/563,643

(22) PCT Filed: Apr. 1, 2016
(86) PCT No.: PCT/AU2016/000111

§ 371 Date: Oct. 2, 2017

(30) Foreign Application Priority Data
Apr. 2, 2015 (AU) 2015901197

(51) Int. Cl. H04N 13/02; G02B 27/01; G06F 3/01; H04N 5/222

(52) U.S. Cl. CPC H04N 13/0278; H04N 5/2224; G06F 3/011; G02B 27/0172

(57) ABSTRACT

A sports broadcasting system for a sports event which includes a location mapping system for the event; data loggers worn by the competitors and officials providing a means to locate the identity and position of the competitor or official on the event area by at (east x and y coordinates; a plurality of virtual reality viewers programmed with the layout of the event area and able to be populated with data relating to the event including a view point and a wireless network to facilitate wireless transmission of data from the data loggers to the virtual reality viewers. The virtual reality viewers are programmed to enable the spectator to view icons of the players and officials as they move about using data transmitted from the data loggers. Spectators are able to use a virtual reality headset or use a cell phone and disposable headset and using the events public wi-fi have a virtual reality environment streamed to them. This allows spectators to see the game from the players vantage point, the umpires vantage point i the ball vantage point or some other point on the playing field.

This invention relates to the provision of a virtual reality view of a sports event particularly to enhance the experience of spectators at a live event.

### BACKGROUND TO THE INVENTION

Spectators at live events don't have a close experience of the action at the event. In motor racing it is not easy for the spectator at the event to see the competitors when they are out of sight. Live broadcasting can enhance the viewing experience in a way that is difficult to emulate at the event. But even so an intimate experience of what is happening is not available.

In a spectator sport like any of the codes of football the spectators at the ground only have a single view point. Live TV broadcasts and replays can enhance the experience but again the spectator is denied an intimate experience of the game. Most sports are very focused on trying to improve the live experience because better broadcast coverage is inclining people to watch the event on TV or internet rather than turn up.

Virtual reality head wear is known which can provide an intimate experience of a landscape or environment. Virtual reality can also be simulated on a cell phone using a head set that holds the phone and includes a pair of lenses to view the cell phone screen. Google have promoted a virtual reality headset which is a disposable cardboard device with application software for the cell phone.

### BRIEF DESCRIPTION OF THE INVENTION

A sports broadcasting system for a sports event which includes

A location mapping system for the event;

Data loggers, won by the participants, providing a means to locate the identity and position of the competitor or official on the event area, by at least x and y coordinates;

A plurality of virtual reality viewers programmed with the layout of the event area and able to be populated with data relating to the event including a view point;

A wireless network to facilitate wireless transmission of data from the data loggers Wherein the virtual reality viewers are programmed to enable the spectator to view icons of the players and officials as they move about using data transmitted from the data loggers.

Icons may be photos, images, animations or any suitable representation of a participant, including game officials, umpires as well as players and coaches.

This invention uses live positional data of the competitors and officials to provide a virtual reality game format. The invention uses a positional tracking system on athletes in a spectator sport (like any football code, American football, AFL, rugby, soccer etc) that may be based on GPS technologies or LPS technologies such as radio triangulation or trilateration. In ball games the ball may also be tracked using LPS or a ball tracking technology such as that disclosed in U.S. Pat. No. 835,791. The optional a ball tracking technology, locates the position of the ball in X, Y and optionally Z coordinates

Spectators at the sports stadium, are able to use a virtual reality headset or use a cell phone and disposable headset and using the events public wi-fi, have a virtual reality environment streamed to them. This allows spectators to see the game from the players vantage point, the umpires vantage point, the ball vantage point or some other point on the playing field. Using an internet connection spectators at a remote location like their home may also experience the same virtual reality environment as a substitute for a television broadcast.

The player positional data is collected using player data loggers preferably those described in U.S. Pat. Nos. 7,715,982 and 8,036,826. Each data logger identifies the player or official and provides a continuous stream of position al data using X,Y coordinates based on the dimensions and orientation of the playing field. The virtual reality device is provided with application software that simulates the playing field and allows this to be populated with icons or animations representing each player or umpire or the bal. The data from the data loggers provides the data to show the changing positions of all participants. Each icon may be identified by a player number and a colour indicating which team they represent and may also include a to photo of the player. The data loggers usually contain 3 dimensional accelerometers and gyroscopes so that vertical movements of players can also be experienced in The virtual reality software allows the viewer to see the participants on the simulated playing field from a particular vantage point. When the spectator turns their head the view sweeps across the equivalent portion of the playing field. If the vantage point is the umpire the spectator can see all that the umpire can see by turning their head. A full 360 view is available as well as overhead or ground views, if the vantage point chosen is above the field of play.

Since the system can use spectators smart phones, stadium wifi, athlete tracking technology and very low cost virtual reality headsets that use the smartphone for processing and display, this invention represents a low cost way to drastically improve the spectator experience and engagement.

In the virtual reality mode the phones internal motion sensors mimic the movement of the users head. This can be mapped into the virtual space.

One of the most impressive and engaging features of both team and racing sports is an agile athlete or manouvreable car, finding their way through traffic and evading opposition, and this technology provides a way to experience this compelling situation from a 1^{st} person perspective.

### DETAILED DESCRIPTION OF THE INVENTION

Preferred embodiments of the invention will be described with reference to the drawings in which:

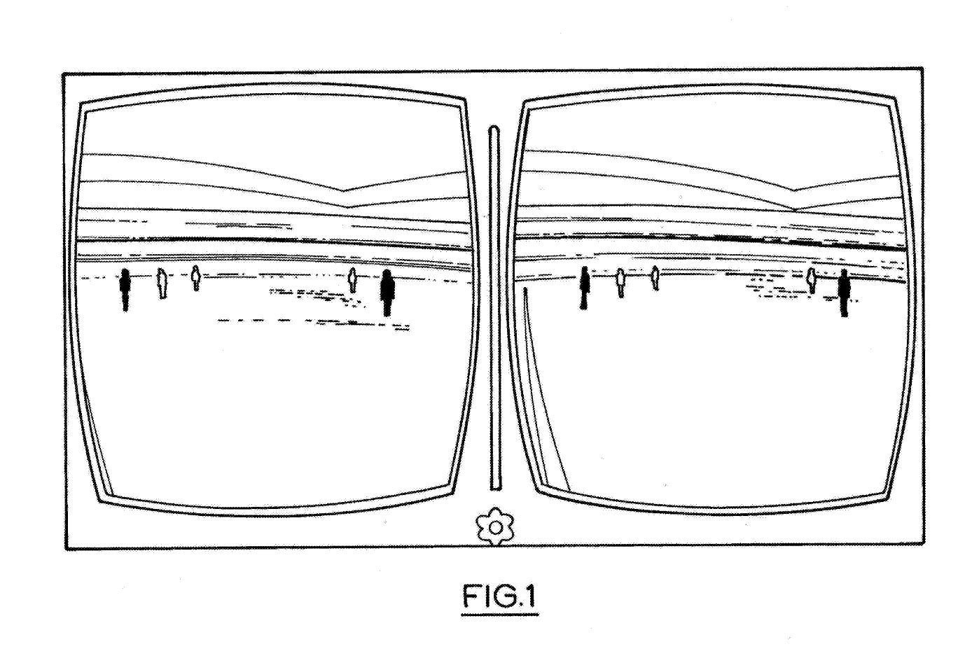

FIG. 1 is a screen shot of a view of an AFL football game from a players view point;

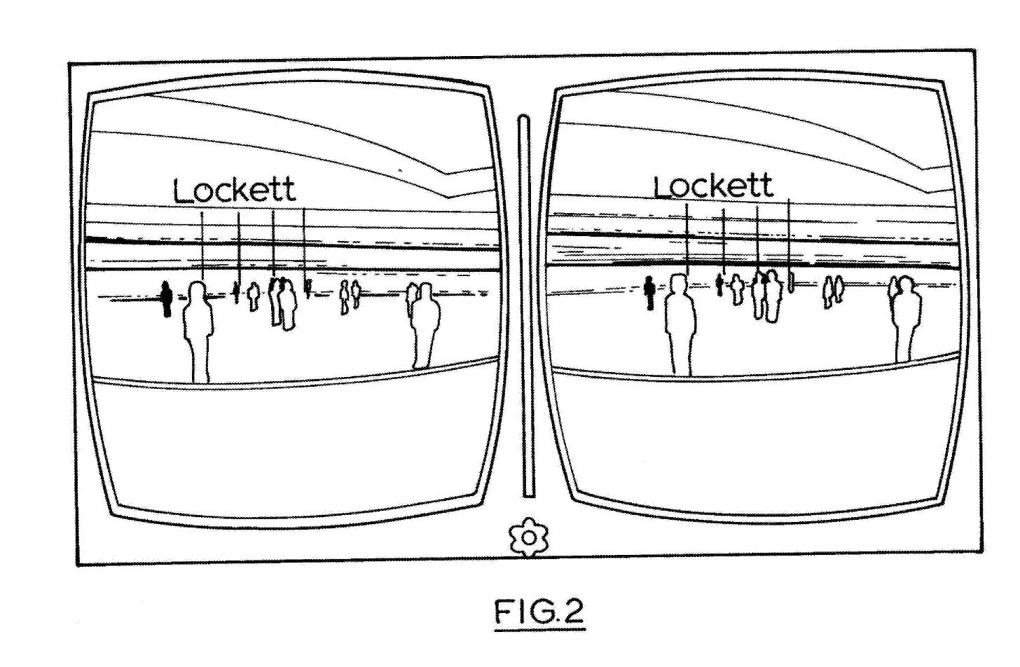

FIG. 2 is a virtual view of a player who is about to kick a goal.

### EXAMPLE AFL—GOAL KICKERS VANTAGE POINT

A player has just picked up the ball through traffic, shrugged off a tackle and kicked a goal. The stadium wi-fl then streams a VR replay. Spectators put their headsets on and see what the player saw. The headsets change their display based on what the spectators are actually looking at in the VR environment—so as they move their head they can actually look around in the VR environment typically made up of animations of players, goals and the stadium. Thus the spectators would see the As another example during a kick in in AFL (FIG. 2), spectators can see from the kickers vantage point all the players around him and see what the options are. The best option may be a team mate that is goal side and unmarked by an opposing player.

Using this example it can also be seen that this invention can be of great benefit to coaches and players and officials in training and particular in reviewing the quality of decision making given the options available. For example if in the kick in example the player had kicked to a marked player when a better option was available, the invention could be used to encourage and develop player vision and assessment of opportunities.

In another example, developing players can replay the game of a star player, seeing the game from his perspective and the choices he makes to pass or carry or tackle in a team sport. In addition, the VR replay can be paused at key decisions to ask the developing player what choice he would make which can then be compared against what the star player did. This is particularly valuable because it can train players in good decision making while they are physically at rest. Since elite sports players can only spend a limited amount of time actually participating in their sports before risking overtraining and injury, training methods that don't involve physical exertion can drastically accelerate the learning of a developing player.

The system is equally applicable to any football code including soccer, the rugby codes and American football (NFL).

Similar examples exist for the other main team sports or car racing (eg. formula 1), race sports like car racing (eg. formula 1), cycling, running or horse racing.

Especially for car racing or cycling, the spectators only see a fraction of the race when the competitors pass them, so being able to then tune in to what the driver or cyclist or runner sees at other points in the race, would increase fan engagement and satisfaction. Again the software application for the event would include a virtual map of the event arena and each participant would be have a data logger either fitted to the vehicle or themselves. Again for participants replaying an event may enable them to review the decision making by each participant as they view the a gap between competitors in front of the viewer, that could have been exploited. Such views are usually not available.

Any suitable VR headset may be used or any cell phone application that provides a virtual reality image. A suitable VR headset is HTC-vive using Valve virtual reality software using a refresh rate of 90 Hz and a 110 degree field of view.

The combination of virtual reality viewing of the playing arena and the provision of continuous location data for each participant provides many opportunities and choices for spectators coaches, umpires and participants during and post the event.

Live video of the event may be provided as a primary feed and the location data and tracking of movements could be provided as an overlay to enhance the understanding. For example providing distance information can provide a better sense of the action. Eg in the AFL example given before, the distance to the goal posts could be graphically provided.

The data may also be overlaid onto a 360 degree video feed produced using 360 degree cameras. A 360 degree camera is a group of cameras that receive images from all directions then stitch all the different camera views into one image (imagine a globe flattened into an atlas). These videos may be viewed using a mouse to look around full 360 degrees on the screen or these videos/images may be viewed in a VR headset. Allowing the use of the head (not a mouse) to choose what can be seen.

From the above it can be seen that this invention provides a unique means of enhancing spectator appreciation of an event. Those skilled in the art will realise that this invention may be implemented in embodiments other than those described without departing from the core teachings of this invention.

1. A sports broadcasting system for a sports event, the system comprising:
a location mapping system for the event;
data loggers worn by participants in the sports event, the data loggers identifying and locating a position of the participants on an event area by at least x and y coordinates;
a plurality of virtual reality viewers programmed with a layout of the event area and configured to be populated with data relating to the event including a view point;
a wireless network to facilitate wireless transmission of data from the data loggers to the virtual reality viewers;
wherein each virtual reality viewer is programmed to enable the spectator to view icons of the players and the officials, as the players and the officials move about, using data transmitted from the data loggers.

2. The system as claimed in claim 1 wherein the sport is a football code, and positional data is provided for the ball, and the participants comprise umpires and players.

3. The system as claimed in claim 2 wherein the view point is a player, the ball or an umpire.

4. The system as claimed in claim 1 wherein the event is a race and the view point is that of a race participant.

5. The system as claimed in claim 4 wherein the event is horse racing and the view point is that of a jockey.

6. The system as claimed in claim 1 wherein the spectators with virtual reality viewers are located in a remote location and access the data via a network.
